(19) United States
(12) Patent Application Publication
(10) Pub. No.: US 2021/0286078 A1
(43) Pub. Date: Sep. 16, 2021

(54) APPARATUS FOR TRACKING OBJECT BASED ON LIDAR SENSOR AND METHOD THEREFOR

(71) Applicants: Hyundai Motor Company, Seoul (KR); Kia Motors Corporation, Seoul (KR)

(72) Inventors: En Sun Lee, Seoul (KR); Hyun Ju Kim, Yongin (KR)

(21) Appl. No.: 17/000,539

(22) Filed: Aug. 24, 2020

(30) Foreign Application Priority Data
Mar. 11, 2020 (KR) 10-2020-0030373

(51) Int. Cl. G01S 17/66; G01S 17/89; G01S 7/48; B60W 40/105

(52) U.S. Cl. CPC G01S 17/66; G01S 17/89; B60W 2420/52; B60W 40/105; G01S 7/4808

(57) ABSTRACT

An apparatus for tracking an object based on a LiDAR sensor and a method therefor are provided. The apparatus includes a LiDAR sensor that generates point cloud data around an autonomous vehicle and a controller that detects objects based on the point cloud data and selects valid objects among the detected objects as targets to be tracked.

### CROSS-REFERENCE TO RELATED APPLICATION

This application claims the benefit of priority to Korean Patent Application No. 10-2020-0030373, filed on Mar. 11, 2020, the entire contents of which are incorporated herein by reference.

### TECHNICAL FIELD

The present disclosure relates to technologies of selecting objects (valid objects) affecting an autonomous vehicle among objects detected based on a light detection and ranging (LiDAR) sensor as targets to be tracked.

### BACKGROUND

In general, a point cloud refers to a set of data on a coordinate system, which is defined as x, y, and z coordinates on a three-dimensional (3D) coordinate system and mostly indicates an external surface of an object. Such a point cloud may be generated by a 3D light detection and ranging (LiDAR) sensor. The 3D LiDAR sensor is loaded into an autonomous vehicle and is mainly used to detect vehicles and lines around the autonomous vehicle and various obstacles.

Since the 3D LiDAR sensor generates a substantial amount of point clouds in an area around the autonomous vehicle, an efficient clustering technology is required. For example, a technology of clustering point clouds projects a point cloud (a 3D point) onto a square grid map in a two-dimensional (2D) form to be converted into a 2D point and uses an “8-neighborhood” technique for the converted 2D point on the square grid map.

Meanwhile, since most object tracking devices have a processing limit on hardware performance, the number of objects capable of being tracked is limited. When the number of objects detected based on a LiDAR sensor is greater than a reference number, a conventional object tracking device first selects reference numbers of the first detected objects as targets to be tracked based on a scan order of the LiDAR sensor. Additionally, since such a conventional object tracking device selects objects to be tracked based on only a scan order of the LiDAR sensor without regard to a situation where an autonomous vehicle is traveling, an object (e.g., a road boundary, an object around the autonomous vehicle, or the like) affecting the driving of the autonomous vehicle is excluded from targets to be tracked.

Details described in the background art are written to increase the understanding of the background of the present disclosure, which may include details rather than an existing technology well known to those skilled in the art.

### SUMMARY

The present disclosure has been made to solve the above-mentioned problems occurring in the prior art while advantages achieved by the prior art are maintained intact. An aspect of the present disclosure provides an apparatus for tracking an object based on a LiDAR sensor to improve driving safety of an autonomous vehicle by detecting objects based on the LiDAR sensor loaded into the autonomous vehicle and selecting objects affecting the driving of the autonomous vehicle among the detected objects as targets to be tracked to track valid objects in a situation where the autonomous vehicle is traveling and a method therefor.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for tracking an object based on a LiDAR sensor may include a LiDAR sensor configured to generate point cloud data around an autonomous vehicle and a controller configured to detect objects based on the point cloud data and selects valid objects among the detected objects as targets to be tracked. In an exemplary embodiment of the present disclosure, the controller may be configured to sequentially exclude objects, each of which has low effectiveness, among the detected objects to select reference numbers of valid objects, based on a reference table corresponding to a situation where the autonomous vehicle is traveling.

In addition, the controller may be configured to select the reference numbers of valid objects based on a first reference table corresponding to a straight road, when a road where the autonomous vehicle is traveling is the straight road. In addition, the controller may be configured to determine the road where the autonomous vehicle is traveling as the straight road, when a speed of the autonomous vehicle is greater than a reference speed and when a curvature of the road is greater than a first reference curvature. The controller may be configured to determine the road where the autonomous vehicle is traveling as the straight road, when a speed of the autonomous vehicle is less than or equal to a reference speed and when a steering angle of the autonomous vehicle is less than or equal to a reference steering angle.

Further, the controller may be configured to select the reference numbers of valid objects based on a second reference table corresponding to a first curved road, when a road where the autonomous vehicle is traveling is the first curved road. In addition, the controller may be configured to determine the road where the autonomous vehicle is traveling as the first curved road, when a speed of the autonomous vehicle is greater than a reference speed and when a curvature of the road is less than or equal to a first reference curvature and is greater than a second reference curvature. The controller may be configured to select the reference numbers of valid objects based on a third reference table corresponding to a second curved road, when a road where the autonomous vehicle is traveling is the second curved road.

In an exemplary embodiment of the present disclosure, the controller may be configured to determine the road where the autonomous vehicle is traveling as the second curved road, when a speed of the autonomous vehicle is greater than a reference speed and when a curvature of the road is less than or equal to a second reference curvature. The controller may be configured to select the reference numbers of valid objects based on a fourth reference table, when a speed of the autonomous vehicle is less than or equal to a reference speed and when a steering angle of the autonomous vehicle is greater than a reference steering angle.

According to another aspect of the present disclosure, a method for tracking an object based on a LiDAR sensor may include generating, by the LiDAR sensor, point cloud data around an autonomous vehicle and detecting, by a controller, objects based on the point cloud data and selecting, by the controller, valid objects among the detected objects as targets to be tracked. In addition, the selecting of the valid objects as the targets to be tracked may include sequentially excluding objects, each of which has low effectiveness, among the detected objects to select reference numbers of valid objects, based on a reference table corresponding to a situation where the autonomous vehicle is traveling.

The selecting of the reference numbers of valid objects may include selecting the reference numbers of valid objects based on a first reference table corresponding to a straight road, when a road where the autonomous vehicle is traveling is the straight road. In an exemplary embodiment of the present disclosure, the selecting of the reference numbers of valid objects may further include determining the road where the autonomous vehicle is traveling as the straight road, when a speed of the autonomous vehicle is greater than a reference speed and when a curvature of the road is greater than a first reference curvature.

The selecting of the reference numbers of valid objects may further include determining the road where the autonomous vehicle is traveling as the straight road, when a speed of the autonomous vehicle is less than or equal to a reference speed and when a steering angle of the autonomous vehicle is less than or equal to a reference steering angle. Additionally, the selecting of the reference numbers of valid objects may include selecting the reference numbers of valid objects based on a second reference table corresponding to a first curved road, when a road where the autonomous vehicle is traveling is the first curved road.

In an exemplary embodiment of the present disclosure, the selecting of the reference numbers of valid objects may include determining the road where the autonomous vehicle is traveling as the first curved road, when a speed of the autonomous vehicle is greater than a reference speed and when a curvature of the road is less than or equal to a first reference curvature and is greater than a second reference curvature. The selecting of the reference numbers of valid objects may include selecting the reference numbers of valid objects based on a third reference table corresponding to a second curved road, when a road where the autonomous vehicle is traveling is the second curved road.

Further, the selecting of the reference numbers of valid objects may include determining the road where the autonomous vehicle is traveling as the second curved road, when a speed of the autonomous vehicle is greater than a reference speed and when a curvature of the road is less than or equal to a second reference curvature. The selecting of the reference numbers of valid objects may include selecting the reference numbers of valid objects based on a fourth reference table, when a speed of the autonomous vehicle is less than or equal to a reference speed and when a steering angle of the autonomous vehicle is greater than a reference steering angle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for tracking an object based on a LiDAR sensor according to an exemplary embodiment of the present disclosure;

FIG. 2 is a drawing illustrating a process of selecting a valid object on a straight road in a valid object selecting device provided in an apparatus for tracking an object based on a LiDAR sensor according to an exemplary embodiment of the present disclosure;

FIG. 3 is a drawing illustrating a process of selecting a valid object on a gentle curved road in a valid object selecting device provided in an apparatus for tracking an object based on a LiDAR sensor according to an exemplary embodiment of the present disclosure;

FIG. 4 is a drawing illustrating a process of selecting a valid object on a sharp curved road in a valid object selecting device provided in an apparatus for tracking an object based on a LiDAR sensor according to an embodiment of the present disclosure;

FIG. 5 is a drawing illustrating a process of selecting a valid object upon steering while a vehicle slows down in a valid object selecting device provided in an apparatus for tracking an object based on a LiDAR sensor according to an exemplary embodiment of the present disclosure;

FIG. 6 is a drawing illustrating a ranking assigned for each line upon a lane change in a valid object selecting device provided in an apparatus for tracking an object based on a LiDAR sensor according to an exemplary embodiment of the present disclosure;

FIGS. 7A-7B are drawings illustrating reference numbers of valid objects selected on a straight road by an apparatus for tracking an object based on a LiDAR sensor according to an exemplary embodiment of the present disclosure;

FIGS. 8A-8B are drawings illustrating reference numbers of valid objects selected on a gentle curved road by an apparatus for tracking an object based on a LiDAR sensor according to an exemplary embodiment of the present disclosure;

FIGS. 9A-9B are drawings illustrating reference numbers of valid objects selected on a sharp curved road by an apparatus for tracking an object based on a LiDAR sensor according to an exemplary embodiment of the present disclosure;

FIGS. 10A-10B are drawings illustrating reference numbers of valid objects selected upon steering while a vehicle slows down by an apparatus for tracking an object based on a LiDAR sensor according to an exemplary embodiment of the present disclosure;

FIG. 11 is a flowchart illustrating a method for tracking an object based on a LiDAR sensor according to an exemplary embodiment of the present disclosure; and

FIG. 12 is a block diagram illustrating a computing system for executing a method for tracking an object based on a LiDAR sensor according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

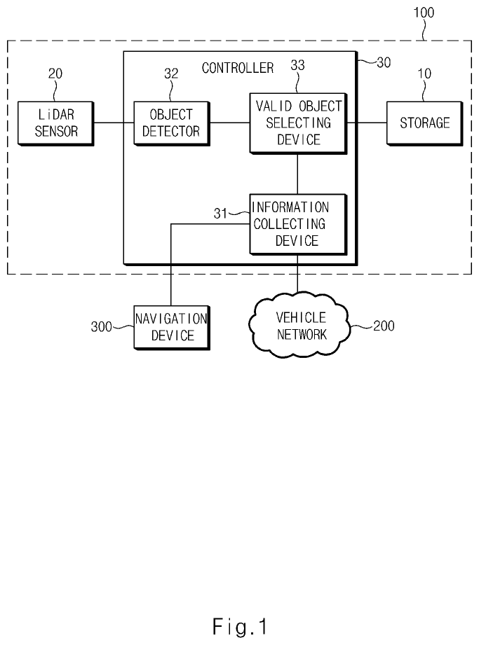

FIG. 1 is a block diagram illustrating a configuration of an apparatus for tracking an object based on a LiDAR sensor according to an exemplary embodiment of the present disclosure. As shown in FIG. 1, an apparatus 100 for tracking an object based on a LiDAR sensor according to an exemplary embodiment of the present disclosure may include a storage 10, a LiDAR sensor 20, and a controller 30. In particular, the respective components may be combined into one component and some components may be omitted, based on a manner which executes the apparatus 100 for tracking the object based on the LiDAR sensor according to an exemplary embodiment of the present disclosure.

Seeing the respective components, first of all, the storage 10 may be configured to store various logics, algorithms, and programs required in a process of detecting objects based on the LiDAR sensor 20 loaded into an autonomous vehicle and selecting objects (valid objects) affecting the driving of the autonomous vehicle among the detected objects as targets to be tracked. The storage 10 may be configured to store a reference steering angle (e.g., 20 degrees) or a reference curvature used to determine a shape of the road. In particular, the reference curvature may include a first reference curvature (e.g., 250 m/rad) and a second reference curvature (e.g., 100 m/rad).

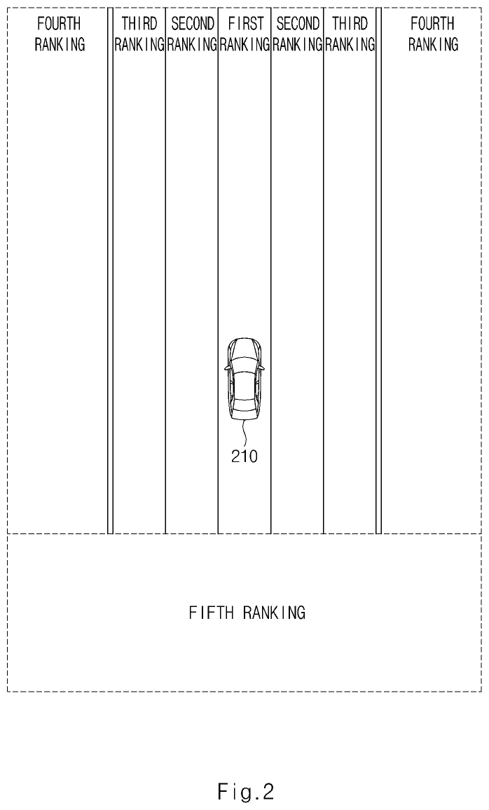

The storage 10 may be configured to store a first reference table used to select a valid object on a straight road. Such a first reference table may include a plurality of step fields for sequentially removing objects, each of which has low effectiveness. For example, the first reference table applied to a straight road shown in FIG. 2 is Table 1 below. In particular, a higher priority may be assigned to a line close based on an autonomous vehicle 210 in a ranking for each line.

TABLE 1

| | |
|---|---|
| Step 1 | Medium Object in fifth ranking |
| Step 2 | Medium Object 40 meters away in lateral |
| | direction, in fourth ranking |
| Step 3 | Rear Small Object in fourth ranking |
| Step 4 | Small Object in fourth ranking |
| Step 5 | Small Object in three ranking |
| Step 6 | Medium Object in three ranking |
| Step 7 | Small Object in second ranking |
| Step 8 | All Objects in fifth, fourth, or third ranking |
| Step 9 | All Object in second ranking |
| Step 10 | Small Object in first ranking |
| Step 11 | All Object in first ranking |

Herein, ‘Step 1’ indicates an object first excluded in selecting a valid object (e.g., an object with the lowest effectiveness), and ‘Step 11’ indicates an object last excluded in selecting a valid object (e.g., an object with the highest effectiveness). In particular, when the number of detected objects is less than or equal to a reference number, all the detected objects may be selected as valid objects. When the number of the detected objects is greater than the reference number, the detected objects may be sequentially excluded from ‘Step 1’.

Furthermore, ‘Small Object’ in the fourth ranking refers to an object, a length of which is less than about 4 m and a width of which is less than about 4 m ‘Small Object’ in the third ranking refers to an object, a length of which is less than about 2 m and a width of which is less than about 2 m. ‘Small Object’ in the first or second ranking refers to an object, a length of which is less than about 1 m and a width of which is less than about 1 m. Furthermore, ‘Medium Object’ is an object except for a stopped object such as a road boundary, which refers to an object, a length of which is less than about 8 m and a width of which is less than about 8 m.

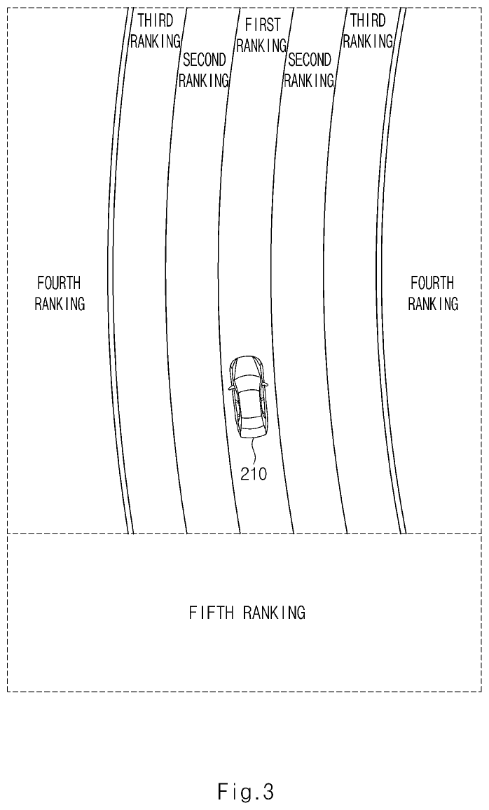

The storage 10 may be configured to store a second reference table used to select a valid object on a gentle curved road. For example, as shown in FIG. 3, the second reference table applied to a gentle curved road is Table 2 below.

TABLE 2

| | |
|---|---|
| Step 1 | Medium Object in fifth ranking |
| Step 2 | Medium Object 40 meters away in lateral |
| | direction, in fourth ranking |
| Step 3 | Rear Small Object in fourth ranking |
| Step 4 | Small Object in fourth ranking |
| Step 5 | Small Object on outer curved road, in third ranking |
| Step 6 | Medium Object in fourth ranking |
| | Medium Object on outer curved road, in third |
| | ranking |
| Step 7 | Small Object on inner curved road, in third ranking |
| | Small Object in second ranking |
| Step 8 | All Objects in fifth or fourth ranking |
| | All Object on outer curved road, in third ranking |
| Step 9 | All Objects on inner curved road, in third ranking |
| | All Objects in second ranking |
| Step 10 | Small Object in first ranking |
| Step 11 | All Objects in first ranking |

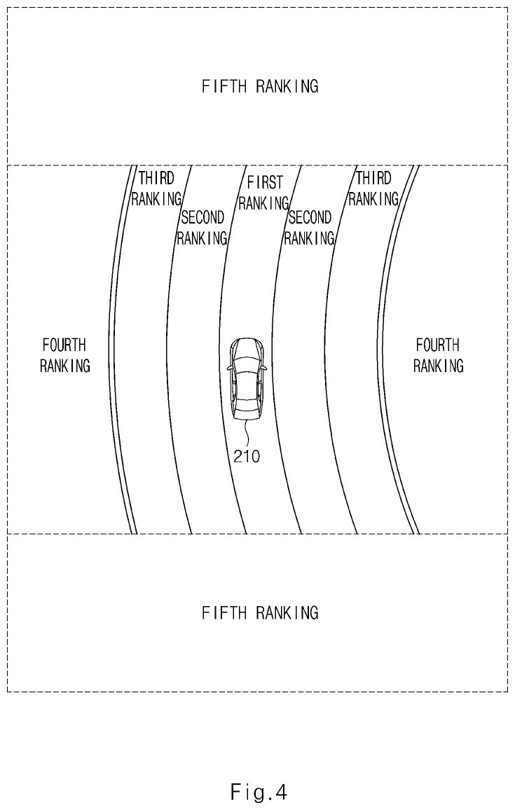

The storage 10 may store a third reference table used to select a valid object on a sharp curved road. For example, as shown in FIG. 4, the third reference table applied to a sharp curved road is Table 3 below.

TABLE 3

| | |
|---|---|
| Step 1 | Medium Object in fifth ranking |
| Step 2 | Medium Object 40 meters away in lateral |
| | direction, in fourth ranking |
| Step 3 | Rear Small Object in fourth ranking |
| Step 4 | Small Object in fourth ranking |
| Step 5 | All Objects in fourth or fifth ranking |
| Step 6 | Small Object on outer curved road, in third ranking |
| Step 7 | Small Object on inner curved road, in third ranking |
| Step 8 | All Objects on outer curved road, in third ranking |
| Step 9 | Small Object in second or first ranking |
| Step 10 | All Objects on inner curved road, in third ranking |
| Step 11 | All Objects in second or first rankings |

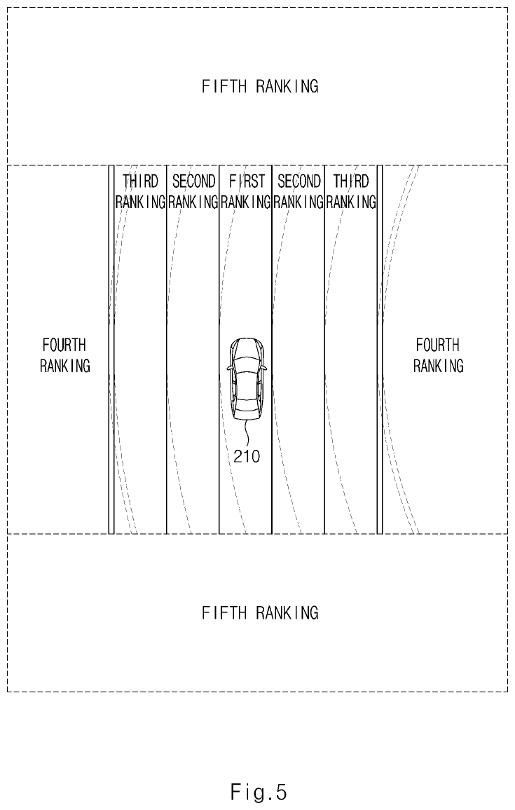

While the autonomous vehicle slows down (e.g., at a speed of about 20 kph or less) and when a steering angle is greater than a reference steering angle (e.g., about 20 degrees), the storage 10 may be configured to store a fourth reference table used to select a valid object. For example, as shown in FIG. 5, the fourth reference table applied while the autonomous vehicle 210 slows down on the road is Table 4 below.

TABLE 4

| | |
|---|---|
| Step 1 | Medium Object in fifth ranking |
| Step 2 | Medium Object 40 meters away in lateral |
| | direction, in fourth ranking |
| Step 3 | Rear Small Object in fourth ranking |
| Step 4 | Small Object in fourth ranking |
| Step 5 | Medium Object in fourth ranking |
| Step 6 | All Objects in fifth or fourth rankings |
| Step 7 | Small Object in third ranking |
| Step 8 | Medium Object in third ranking |
| Step 9 | All Objects in third ranking |
| Step 10 | Small Object in second or first rankings |
| Step 11 | All Objects in second or first ranking |

The storage 10 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The LiDAR sensor 20 may be loaded into the autonomous vehicle to generate point cloud data for objects around the autonomous vehicle. The controller 30 may be configured to perform overall control such that respective components may normally perform their own functions. Such a controller 30 may be implemented in the form of hardware, may be implemented in the form of software, or may be implemented in the form of a combination thereof. Preferably, the controller 30 may be implemented as, but not limited to, a microprocessor.

Particularly, the controller 30 may be configured to perform a variety of control in a process of detecting objects based on the LiDAR sensor 20 loaded into the autonomous vehicle and selecting objects (valid objects) affecting the driving of the autonomous vehicle among the detected objects as targets to be tracked. The controller 30 may include an information collecting device 31, an object detector 32, and a valid object selecting device 33 as functional blocks. Hereinafter, the operation of the controller 30 will be described in detail based on each functional block.

The information collecting device 31 may have a communication interface with a vehicle network 200 and may be configured to collect a variety of information over the vehicle network 200. For example, the information collecting device 31 may be configured to collect steering angle information, vehicle speed information, yaw rate information, turn signal information (turn signal ON information), or the like over the vehicle network 200. In particular, the vehicle network 200 may include a controller area network (CAN), a local interconnect network (LIN), FlexRay, media oriented systems transport (MOST), an Ethernet, or the like. The information collecting device 31 may interwork with a navigation device 300 provided in the autonomous vehicle to collect destination path information.

The object detector 32 may be configured to detect objects based on the point cloud data obtained through the LiDAR sensor 20. In particular, since the detection of the object is well known and commonly used and is not the gist of the present disclosure, a detailed description thereof will be omitted. The valid object selecting device 33 may be configured to select a valid object among the objects detected by the object detector 32, based on the plurality of reference tables stored in the storage 10 and the information collected by the information collecting device 31. In other words, the valid object selecting device 33 may be configured to specify one of the plurality of reference tables based on the information collected by the information collecting device 31 and select a valid object based on the specified reference table.

Hereinafter, the operation of the valid object selecting device 33 will be described with reference to FIGS. 2 to 6. FIG. 2 is a drawing illustrating a process of selecting a valid object on a straight road in a valid object selecting device provided in an apparatus for tracking an object based on a LiDAR sensor according to an exemplary embodiment of the present disclosure.

First of all, when the vehicle speed collected by an information collecting device 31 of FIG. 1 is greater than a reference speed (e.g., about 20 kph) and when a curvature of the road where an autonomous vehicle 210 is traveling is greater than a first reference curvature (e.g., about 250 m/rad), a valid object selecting device 33 of FIG. 1 may be configured to determine the road where the autonomous vehicle 210 is traveling as a straight road. In particular, the valid object selecting device 33 may be configured to calculate curvature based on the vehicle speed and the yaw rate collected by the information collecting device 31. Since the detailed manner to calculate the curvature is well known and commonly used, a description thereof will be omitted.

Furthermore, when the vehicle speed collected by the information collecting device 31 is less than or equal to the reference speed (e.g., about 20 kph) and when a steering angle of the autonomous vehicle 210 is less than or equal to a reference steering angle (e.g., about 20 degrees), the valid object selecting device 33 may be configured to determine the road where the autonomous vehicle 210 is traveling as a straight road. In response to determining that the road where the autonomous vehicle 210 is traveling is the straight road, the valid object selecting device 33 may be configured to select a valid object based on a first reference table stored in a storage 10 of FIG. 1.

When the number of objects detected by an object detector 32 of FIG. 1 is less than or equal to a reference number (e.g., about 50), the valid object selecting device 33 may be configured to select all the detected objects as valid objects. When the number of the detected objects is greater than the reference number, the valid object selecting device 33 may be configured to sequentially exclude objects from objects corresponding to ‘Step 1’ to objects corresponding to ‘Step 11’ to select reference numbers of valid objects.

FIG. 3 is a drawing illustrating a process of selecting a valid object on a gentle curved road in a valid object selecting device provided in an apparatus for tracking an object based on a LiDAR sensor according to an exemplary embodiment of the present disclosure. First of all, when the vehicle speed collected by an information collecting device 31 of FIG. 1 is greater than a reference speed (e.g., about 20 kph) and when curvature calculated based on the vehicle speed and the yaw rate collected by the information collecting device 31 is less than or equal to a first reference curvature (e.g., about 250 m/rad) and is greater than a second reference curvature (e.g., about 100 m/rad), a valid object selecting device 33 of FIG. 1 may be configured to determine the road where an autonomous vehicle 210 is traveling as a gentle curved road.

In response to determining that the road where the autonomous vehicle 210 is traveling is the gentle curved road, the valid object selecting device 33 may be configured to select a valid object based on a second reference table stored in a storage 10 of FIG. 1. When the number of objects detected by an object detector 32 of FIG. 1 is less than or equal to a reference number (e.g., about 50), the valid object selecting device 33 may be configured to select all the detected objects as valid objects. In response to determining that the number of the detected objects is greater than the reference number, the valid object selecting device 33 may be configured to sequentially exclude objects from ‘Step 1’ to select reference numbers of valid objects.

FIG. 4 is a drawing illustrating a process of selecting a valid object on a sharp curved road in a valid object selecting device provided in an apparatus for tracking an object based on a LiDAR sensor according to an exemplary embodiment of the present disclosure. First of all, when the vehicle speed collected by an information collecting device 31 of FIG. 1 is greater than a reference speed (e.g., about 20 kph) and when curvature calculated based on the vehicle speed and the yaw rate collected by the information collecting device 31 is less than or equal to a second reference curvature (e.g., about 100 m/rad), a valid object selecting device 33 of FIG. 1 may be configured to determine the road where an autonomous vehicle 210 is traveling as a sharp curved road.

In response to determining that the road where the autonomous vehicle 210 is traveling is the sharp curved road, the valid object selecting device 33 may be configured to select a valid object based on a third reference table stored in a storage 10 of FIG. 1. When the number of objects detected by an object detector 32 of FIG. 1 is less than or equal to a reference number (e.g., about 50), the valid object selecting device 33 may be configured to select all the detected objects as valid objects. When the number of the detected objects is greater than the reference number, the valid object selecting device 33 may be configured to sequentially exclude objects from ‘Step 1’ to select reference numbers of valid objects. In FIG. 4, a fifth ranking refers to a front outer area and a rear outer area of the curved road (e.g., a first ranking, a second ranking, and a third ranking).

FIG. 5 is a drawing illustrating a process of selecting a valid object upon steering while an autonomous vehicle slows down in a valid object selecting device provided in an apparatus for tracking an object based on a LiDAR sensor according to an exemplary embodiment of the present disclosure. First of all, when the vehicle speed collected by an information collecting device 31 of FIG. 1 is less than or equal to a reference speed (e.g., about 20 kph) and when a steering angle of an autonomous vehicle 210 is greater than a reference steering angle (e.g., about 20 degrees), a valid object selecting device 33 of FIG. 1 may be configured to determine that the autonomous vehicle 210 is being steered while slowing down.

In response to determining that the autonomous vehicle 210 is being steered while slowing down, the valid object selecting device 33 may be configured to select a valid object based on a fourth reference table stored in a storage 10 of FIG. 1. When the number of objects detected by an object detector 32 of FIG. 1 is less than or equal to a reference number (e.g., about 50), the valid object selecting device 33 may be configured to select all the detected objects as valid objects. When the number of the detected objects is greater than the reference number, the valid object selecting device 33 may be configured to sequentially exclude objects from ‘Step 1’ to select reference numbers of valid objects.

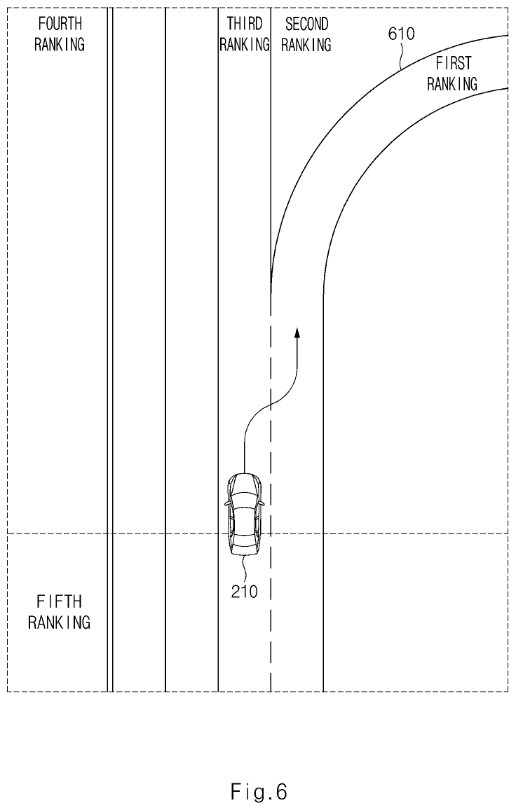

FIG. 6 is a drawing illustrating a ranking assigned for each line upon a lane change in a valid object selecting device provided in an apparatus for tracking an object based on a LiDAR sensor according to an exemplary embodiment of the present disclosure. First of all, a valid object selecting device 33 of FIG. 1 may be configured to determine an intention of a driver to perform a lane change based on turn signal information and steering angle information collected by an information collecting device 31 of FIG. 1. Furthermore, the valid object selecting device 33 may be configured to determine an intention of an autonomous vehicle 210 to perform a lane change based on navigation path information collected by the information collecting device 31.

When the intention of the driver to perform a lane change or the intention of the autonomous vehicle 210 to perform a lane change is determined, the valid object selecting device 33 may be configured to change a ranking assigned for each line. As shown in FIG. 6, when the autonomous vehicle 210 attempts to enter an exit ramp 610 from the road where it is traveling, the valid object selecting device 33 may be configured to change a ranking for each line. In other words, the valid object selecting device 33 may be configured to set the exit ramp 610 to a first ranking, set the periphery of the exit ramp 620 to a second ranking, and set the line where the autonomous vehicle 21 is currently traveling to a third ranking.

Thereafter, the valid object selecting device 33 may be configured to select reference numbers of valid objects among objects detected by an object detector 32 of FIG. 1 as targets to be tracked based on a reference table corresponding to a shape of the exit ramp 610. In FIG. 6, a second ranking refers to a two-sided area of the exit ramp 610.

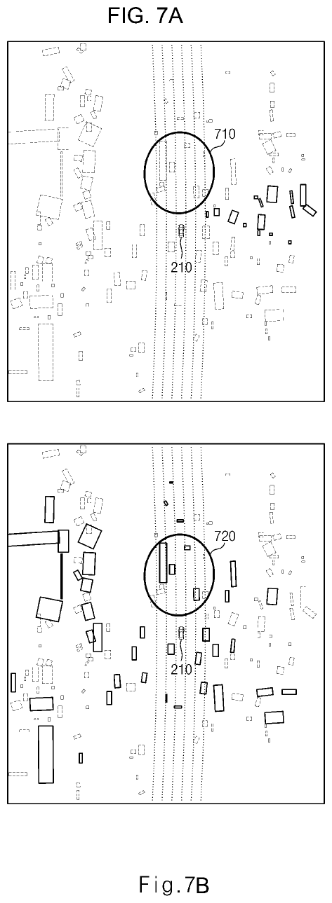

FIGS. 7A-7B are drawings illustrating reference numbers of valid objects selected on a straight road by an apparatus for tracking an object based on a LiDAR sensor according to an exemplary embodiment of the present disclosure. In FIGS. 7A-7B, objects displayed in a dotted line (rectangular dotted lines) indicate objects detected by an object detector 32 of FIG. 1, and objects displayed in a solid line (rectangular solid lines) indicate valid objects selected by a valid object selecting device 33 of FIG. 1.

Since an existing method selects reference numbers of valid objects as targets to be tracked based on a scan order of a LiDAR sensor 20 of FIG. 1 without regard to a situation where an autonomous vehicle 210 is traveling, as shown in reference numeral 710, it may be seen that valid objects (e.g., a vehicle, a guardrail, and the like) are excluded from the targets to be tracked. Additionally, since a method according to an exemplary embodiment of the present disclosure selects reference numbers of valid objects as targets to be tracked with regard to a situation where the autonomous vehicle 210 is traveling (e.g., a shape of the road, an intention to perform a lane change, whether the autonomous vehicle 201 slows down, or the like), as shown in reference numeral 720, it may be seen that valid objects (e.g., a vehicle, a guardrail, and the like) are included in the targets to be tracked.

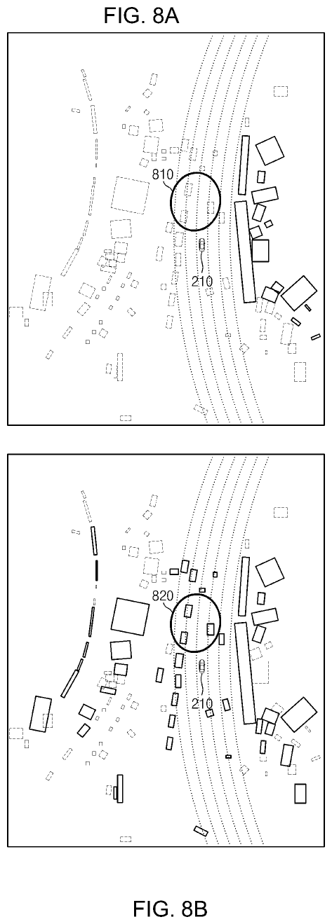

FIGS. 8A-8B are drawings illustrating reference numbers of valid objects selected on a gentle curved road by an apparatus for tracking an object based on a LiDAR sensor according to an embodiment of the present disclosure. In FIGS. 8A-8B, objects displayed in a dotted line (rectangular dotted lines) indicate objects detected by an object detector 32 of FIG. 1, and objects displayed in a solid line (rectangular solid lines) indicate valid objects selected by a valid object selecting device 33 of FIG. 1.

Since an existing method selects reference numbers of valid objects as targets to be tracked based on a scan order of a LiDAR sensor 20 of FIG. 1 without regard to a situation where an autonomous vehicle 210 is traveling, as shown in reference numeral 810, it may be seen that valid objects (e.g., a vehicle, a guardrail, and the like) are excluded from the targets to be tracked. Additionally, since a method according to an exemplary embodiment of the present disclosure selects reference numbers of valid objects as targets to be tracked with regard to a situation where the autonomous vehicle 210 is traveling (e.g., a shape of the road, an intention to perform a lane change, whether the autonomous vehicle 201 slows down, or the like), as shown in reference numeral 820, it may be seen that valid objects (e.g., a vehicle, a guardrail, and the like) are included in the targets to be tracked.

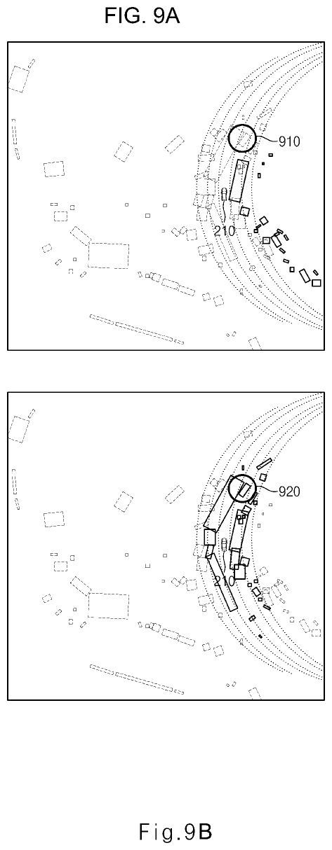

FIGS. 9A-9B are drawings illustrating reference numbers of valid objects selected on a sharp curved road by an apparatus for tracking an object based on a LiDAR sensor according to an exemplary embodiment of the present disclosure. In FIGS. 9A-9B, objects displayed in a dotted line (rectangular dotted lines) indicate objects detected by an object detector 20 of FIG. 1, and objects displayed in a solid line (rectangular solid lines) indicate valid objects selected by a valid object selecting device 33 of FIG. 1.

Since an existing method selects reference numbers of valid objects as targets to be tracked based on a scan order of a LiDAR sensor 20 of FIG. 1 without regard to a situation where an autonomous vehicle 210 is traveling, as shown in reference numeral 910, it may be seen that valid objects (e.g., a vehicle, a guardrail, and the like) are excluded from the targets to be tracked. Additionally, since a method according to an exemplary embodiment of the present disclosure selects reference numbers of valid objects as targets to be tracked with regard to a situation where the autonomous vehicle 210 is traveling (e.g., a shape of the road, an intention to perform a lane change, whether the autonomous vehicle 201 slows down, or the like), as shown in reference numeral 920, it may be seen that valid objects (e.g., a vehicle, a guardrail, and the like) are included in the targets to be tracked.

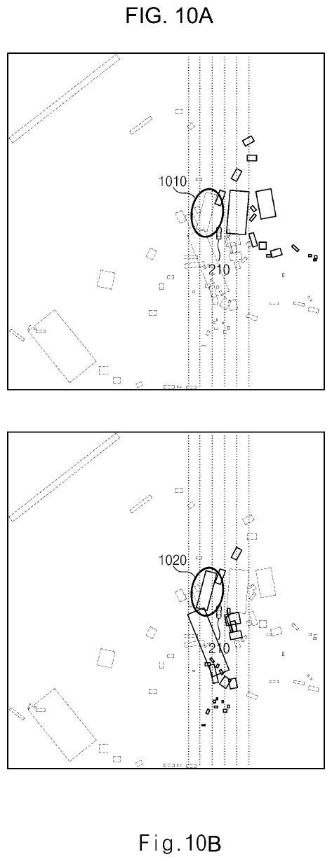

FIGS. 10A-10B are drawings illustrating reference numbers of valid objects selected upon steering while a vehicle slows down by an apparatus for tracking an object based on a LiDAR sensor according to an exemplary embodiment of the present disclosure. In FIG. 10, objects displayed in a dotted line (rectangular dotted lines) indicate objects detected by an object detector 20 of FIG. 1, and objects displayed in a solid line (rectangular solid lines) indicate valid objects selected by a valid object selecting device 33 of FIG. 1.

Since an existing method selects reference numbers of valid objects as targets to be tracked based on a scan order of a LiDAR sensor 20 of FIG. 1 without regard to a situation where an autonomous vehicle 210 is traveling, as shown in reference numeral 1010, it may be seen that valid objects (e.g., a vehicle, a guardrail, and the like) are excluded from the targets to be tracked. Additionally, since a method according to an additionally embodiment of the present disclosure selects reference numbers of valid objects as targets to be tracked with regard to a situation where the autonomous vehicle 210 is traveling (e.g., a shape of the road, an intention to perform a lane change, whether the autonomous vehicle 201 slows down, or the like), as shown in reference numeral 1020, it may be seen that valid objects (e.g., a vehicle, a guardrail, and the like) are included in the targets to be tracked.

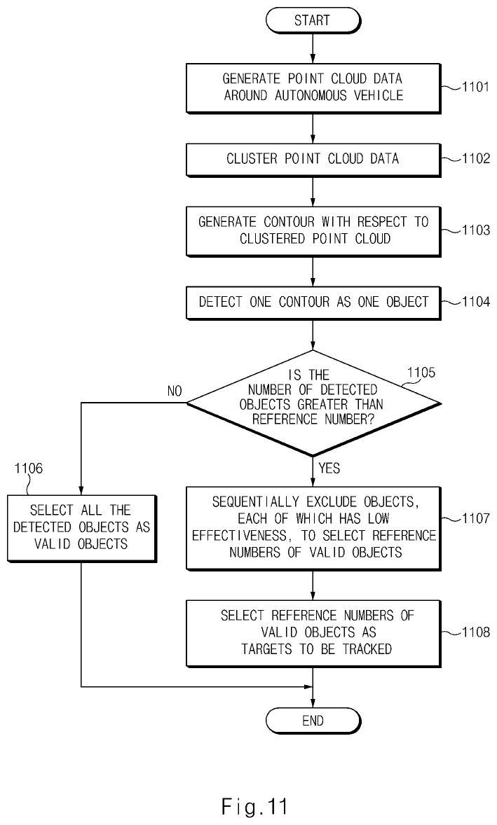

FIG. 11 is a flowchart illustrating a method for tracking an object based on a LiDAR sensor according to an exemplary embodiment of the present disclosure. First of all, in operation 1101, a LiDAR sensor 20 of FIG. 1 may be configured to generate point cloud data around an autonomous vehicle. In operation 1102, a controller 30 of FIG. 1 may be configured to cluster the point cloud data generated by the LiDAR sensor 20. In operation 1103, the controller 30 may be configured to generate a contour with respect to the clustered point cloud. In operation 1104, the controller 30 may be configured to detect one contour as one object.

Herein, operation 1102, operation 1103, and operation 1104 are collectively referred to as an object detection process. Such an object detection process is not the gist of the present disclosure and is fine to use any well-known and commonly-used technology. In operation 1105, the controller 30 may be configured to determine whether the number of the detected objects is greater than a reference number (e.g., 50).

In response to determining that the number of the detected objects is less than or equal to the reference number (e.g., 50) as a result of the determination in operation 1105, in operation 1106, the controller 30 may be configured to select all the detected objects as valid objects. In response to determining that the number of the detected objects is greater than the reference number as a result of the determination in operation 1105, in operation 1107, the controller 30 may be configured to sequentially exclude objects from objects, each of which has low effectiveness, to select reference numbers of valid objects. In particular, the manner where the controller 30 selects the reference numbers of valid objects is as follows:

1) When the road where the autonomous vehicle is traveling is a straight road, the controller 30 may be configured to select the reference numbers of valid objects based on a first reference table corresponding to the straight road.
2) When the road where the autonomous vehicle is traveling is a first curved road, the controller 30 may be configured to select the reference numbers of valid objects based on a second reference table corresponding to the first curved road.
3) When the road where the autonomous vehicle is traveling is a second curved road, the controller 30 may be configured to select the reference numbers of valid objects based on a third reference table corresponding to the second curved road.
4) When the speed of the autonomous vehicle is less than or equal to a reference speed and when the steering angle of the autonomous vehicle is greater than a reference steering angle, the controller 30 may be configured to select the reference numbers of valid objects based on a fourth reference table.

In operation 1108, the controller 30 may be configured to select the reference numbers of valid objects as targets to be tracked.

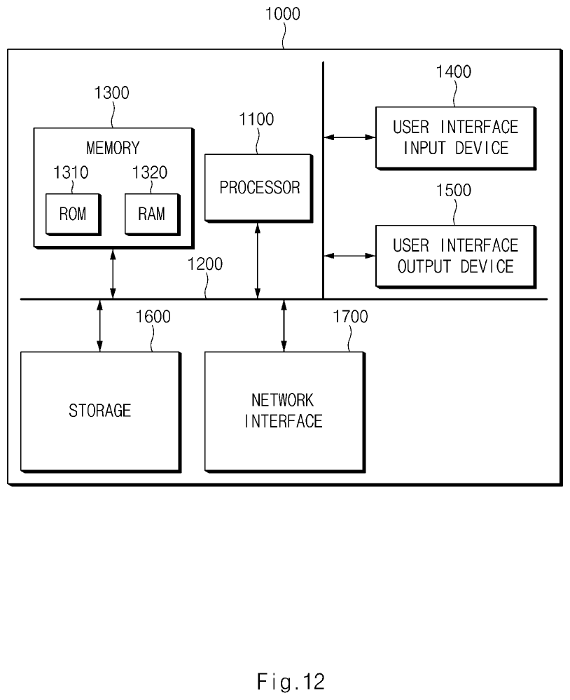

FIG. 12 is a block diagram illustrating a computing system for executing a method for tracking an object based on a LiDAR sensor according to an exemplary embodiment of the present disclosure. Referring to FIG. 12, the method for tracking the object based on the LiDAR sensor according to an exemplary embodiment of the present disclosure may be implemented by the computing system. A computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus for tracking the object based on the LiDAR sensor and the method therefor may improve driving safety of an autonomous vehicle by detecting objects based on the LiDAR sensor loaded into the autonomous vehicle and selecting objects affecting the driving of the autonomous vehicle among the detected objects as targets to be tracked to track valid objects in a situation where the autonomous vehicle is traveling.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for tracking an object based on a light detection and ranging (LiDAR) sensor, comprising:
a LiDAR sensor configured to generate point cloud data around an vehicle; and
a controller configured to detect objects based on the point cloud data and select valid objects among the detected objects as targets to be tracked.

2. The apparatus of claim 1, wherein the controller is configured to sequentially exclude objects, each of which has low effectiveness, among the detected objects to select reference numbers of valid objects, based on a reference table corresponding to a situation where the vehicle is traveling.

3. The apparatus of claim 2, wherein the controller is configured to select the reference numbers of valid objects based on a first reference table corresponding to a straight road, in response to determining that a road where the vehicle is traveling is the straight road.

4. The apparatus of claim 3, wherein the controller is configured to determine the road where the vehicle is traveling as the straight road, in response to determining that a speed of the vehicle is greater than a reference speed and a curvature of the road is greater than a first reference curvature.

5. The apparatus of claim 3, wherein the controller is configured to determine the road where the vehicle is traveling as the straight road, in response to determining that a speed of the vehicle is less than or equal to a reference speed and a steering angle of the is less than or equal to a reference steering angle.

6. The apparatus of claim 2, wherein the controller is configured to select the reference numbers of valid objects based on a second reference table corresponding to a first curved road, in response to determining that a road where the vehicle is traveling is the first curved road.

7. The apparatus of claim 6, wherein the controller is configured to determine the road where the vehicle is traveling as the first curved road, in response to determining that a speed of the vehicle is greater than a reference speed and a curvature of the road is less than or equal to a first reference curvature and is greater than a second reference curvature.

8. The apparatus of claim 2, wherein the controller is configured to select the reference numbers of valid objects based on a third reference table corresponding to a second curved road, in response to determining that a road where the vehicle is traveling is the second curved road.

9. The apparatus of claim 8, wherein the controller is configured to determine the road where the vehicle is traveling as the second curved road, in response to determining that a speed of the vehicle is greater than a reference speed and a curvature of the road is less than or equal to a second reference curvature.

10. The apparatus of claim 2, wherein the controller is configured to select the reference numbers of valid objects based on a fourth reference table, in response to determining that a speed of the vehicle is less than or equal to a reference speed and a steering angle of the vehicle is greater than a reference steering angle.

11. A method for tracking an object based on a LiDAR sensor, the method comprising:
generating, by the LiDAR sensor, point cloud data around an vehicle;
detecting, by a controller, objects based on the point cloud data; and
selecting, by the controller, valid objects among the detected objects as targets to be tracked.

12. The method of claim 11, wherein the selecting of the valid objects as the targets to be tracked includes:
sequentially excluding objects, each of which has low effectiveness, among the detected objects to select reference numbers of valid objects, based on a reference table corresponding to a situation where the vehicle is traveling.

13. The method of claim 12, wherein the selecting of the reference numbers of valid objects includes:
selecting the reference numbers of valid objects based on a first reference table corresponding to a straight road, in response to determining that a road where the vehicle is traveling is the straight road.

14. The method of claim 13, wherein the selecting of the reference numbers of valid objects further includes:
determining the road where the vehicle is traveling as the straight road, in response to determining that a speed of the vehicle is greater than a reference speed and a curvature of the road is greater than a first reference curvature.

15. The method of claim 13, wherein the selecting of the reference numbers of valid objects further includes:
determining the road where the vehicle is traveling as the straight road, in response to determining that a speed of the vehicle is less than or equal to a reference speed and a steering angle of the vehicle is less than or equal to a reference steering angle.

16. The method of claim 12, wherein the selecting of the reference numbers of valid objects includes:
selecting the reference numbers of valid objects based on a second reference table corresponding to a first curved road, in response to determining that a road where the vehicle is traveling is the first curved road.

17. The method of claim 16, wherein the selecting of the reference numbers of valid objects further includes:
determining the road where the vehicle is traveling as the first curved road, in response to determining that a speed of the vehicle is greater than a reference speed and a curvature of the road is less than or equal to a first reference curvature and is greater than a second reference curvature.

18. The method of claim 12, wherein the selecting of the reference numbers of valid objects includes:
selecting the reference numbers of valid objects based on a third reference table corresponding to a second curved road, in response to determining that a road where the vehicle is traveling is the second curved road.

19. The method of claim 18, wherein the selecting of the reference numbers of valid objects further includes:
determining the road where the vehicle is traveling as the second curved road, in response to determining that a speed of the vehicle is greater than a reference speed and a curvature of the road is less than or equal to a second reference curvature.

20. The method of claim 12, wherein the selecting of the reference numbers of valid objects includes:
selecting the reference numbers of valid objects based on a fourth reference table, in response to determining that a speed of the vehicle is less than or equal to a reference speed and a steering angle of the vehicle is greater than a reference steering angle.
